(19) United States
(12) Patent Application Publication
(10) Pub. No.: US 2010/0088151 A1
(43) Pub. Date: Apr. 8, 2010

(54) METHOD AND APPARATUS FOR RECOMMENDING IMAGE BASED ON USER PROFILE USING FEATURE-BASED COLLABORATIVE FILTERING TO RESOLVE NEW ITEM RECOMMENDATION

(76) Inventors: Deok Hwan KIM, Seoul (KR); Won Hee CHO, Bupyeong-gu (KR); Jun Sik YANG, Bupyeong-gu (KR)

Correspondence Address: North Star Intellectual Property Law, PC, P.O. Box 34688, Washington DC, DC, 20043, US

(21) Appl. No.: 12/390,361

(22) Filed: Feb. 20, 2009

(30) Foreign Application Priority Data
Oct. 8, 2008 (KR) 10-2008-0098860

(51) Int. Cl. G06Q 30/00

(52) U.S. Cl. 705/10

(57) ABSTRACT

Provided are a method and apparatus for recommending an image based on a user profile using feature-based collaborative filtering. To generate the user profile, a model may be build from a customer purchase list database for each predetermined time. A multimedia image may be recommended, in which a purchase likeness score of a target user is high or at a predetermined level, by using the built model.

### CROSS-REFERENCE TO RELATED APPLICATION(S)

This application claims the benefit under 35 U.S.C. §119(a) of a Korean Patent Application No. 10-2008-0098860, filed on Oct. 8, 2008 in the Korean Intellectual Property Office, the entire disclosure of which is hereby incorporated by reference.

### TECHNICAL FIELD

The following disclosure relates to a method and apparatus for recommending an image based on a user profile, and in particular, to a method and apparatus for recommending an image based on a user profile using feature-based collaborative filtering to resolve new item recommendation.

### BACKGROUND

The wired Internet has evolved into the wireless Internet and also into ubiquitous networks. Accordingly, a variety of multimedia contents such as an image, music and video are being provided to users over the wired/wireless communication networks. A portable terminal may receives a multimedia service in a mobile Internet environment. However, due to a small liquid crystal display (LCD) screen, input restrictions of the portable terminal, and limitations of an access browser, it is difficult to freely perform a search, and accordingly, a user's satisfaction of the search may be low compared to a search performed in the existing wired web environment.

Accordingly, it is believed that individual services more suitable for a private rating will lead to the future development of an improved multimedia service. By catching hold of each user's rating on time to provide only multimedia contents suitable for individual ratings, the need for a personalized multimedia recommendation system which supports customers to find desired contents with less effort is being proposed.

In general, a recommendation system is a system that recommends an item suitable for each user's rating using a statistical scheme and a knowledge discovery technology, and is a system that provides convenience to a customer and concentrates on cross sale and sale growth. Various recommendation schemes have been developed to realize a recommendation system. Among the conventional recommendation schemes, a Collaborative Filtering (CF) may be known as a successful recommendation scheme, and is widely used in e-business sites such as “Amazon.com” and “CDNow.”

A CF-based recommendation system is a system that reflects the opinions of the customers having a rating similar to that of a customer intending to recommend an item to thereby predict the rating of an item which a customer for recommendation has not already purchased, and thereafter recommends an item which is predicted to be highly preferred to the customer. The existing CF-based recommendation process may be largely classified into three stages, that is, an input data configuration stage, a neighborhood search stage, and a recommendation item determination stage. (1) Input data in the CF-based recommendation system are generally composed of a rating set of the m number of customers for the n number of items, which is represented as a m*n customer-item matrix P. For example, in a case of predicting rating with a purchase data, P_{i,j} being a value of the ith row and jth column of the matrix P has the value of 1 when the ith customer purchases the jth item, and the P_{i,j} has the value of 0 when the ith customer does not purchase the jth item. (2) A similar rating cluster search may be the most important stage in the CF-based recommendation system, and is a stage that finds the neighborhood of the j number of customers having the most similar rating in the i number of customers with the customer-item matrix P. Generally, pearson correlation and cosine projection are used as a inter-customer similarity measurement scheme. (3) Recommendation item determination is a final stage in the item recommendation, and the λ number of recommendation items are determined from a predetermined neighborhood. Most-frequent item recommendation is generally used as a criterion for the selection of the recommendation items. The most-frequent item recommendation is a method that analyzes a purchase history data for the neighborhood of a corresponding customer and recommends the λ number of items of high purchase frequency by item.

Although the collaborative filtering may be known as one of the more successful recommendation scheme and is being applied to various Internet business fields, in a case where input data related to customer's rating are sparse, the accuracy of a recommendation result is very low. Moreover, in a case of a new item, since the rating of the item is not known, the item cannot be recommended before someone inputs the rating of the item or purchases it. Consequently, the collaborative filtering may not be suitable for the recommendation of multimedia contents.

### SUMMARY

Accordingly, there is provided a method for recommending a multimedia image based on a user profile using feature-based collaborative filtering, the method including building a model from a customer purchase list database for each predetermined time to generate the user profile, and recommending the multimedia image, in which a purchase likeness score of a target user is at a predetermined level, for example, high, by using the built model.

The generating of the user profile may include dividing an image into a plurality of meaning regions on all images of the customer purchase list database by using a feature vector of a multidimensional attribute space, extracting a feature from the divided regions of the image to map the extracted feature on a feature space, and analyzing the customer purchase list database, representing an image purchased by a user as a set of feature clusters based on a user's rating, and generating the user profile.

The dividing of the image may include treating each pixel of all the images of the customer purchase list database as a dot of the feature space by using the feature vector of the multidimensional attribute space, and dividing the image by bunching similar pixels according to a selected feature.

The feature extracted from the divided regions of the image may include at least one of a size of the region, a position of the region, a second moment, a color of the region and texture, which are extracted from the divided regions of the image.

The feature cluster may include at least one of dots represented as regions of a plurality of images that an arbitrary user purchased, a center, variance and effective radius of a cluster and information for a user that has purchased the image of the cluster.

The recommending of the multimedia image may include setting a neighborhood by using multimedia image contents in profiles of a target user and an arbitrary user, and generating an image recommendation list on the basis of the set neighborhood.

The setting of the neighborhood may include configuring each cluster by using the multimedia image contents in the profiles of the target user and the arbitrary user, calculating a distance between the each cluster through a query, selecting a neighbor cluster according to the calculated distance, and setting a similarity cluster for a target user of the neighbor cluster.

The method may further include determining a cluster to enter a new multimedia image content, when the new multimedia image content, which was not purchased in the past and is not included in a cluster of each user, is provided, and entering the new multimedia image content into the similarity cluster, when the new multimedia image content is within an effective radius of the determined cluster.

The generating of the image recommendation list may include extracting the specific number of upper multimedia image contents, in which a frequency of purchase is high, from the set neighborhood to generate the image recommendation list.

According to another aspect, there is provided a computer-readable storage medium storing a program for executing one or more operations of the method.

According to still another aspect, there is provided an apparatus for recommending a multimedia image based on a user profile using feature-based collaborative filtering, the apparatus including an image dividing unit dividing an image into a plurality of meaning regions on all images of a customer purchase list database by using a feature vector, a feature extracting unit extracting a feature from the regions of the image divided by the image dividing unit to map the extracted feature on a feature space, a user profile generating unit analyzing the customer purchase list database, representing an background image purchased by a user as a set of feature clusters based on a user's rating, and generating a user profile, a neighborhood setting unit setting a neighborhood by using multimedia image contents in profiles of a target user and an arbitrary user, and a recommendation list generating unit generating a background image recommendation list on the basis of the neighborhood set by the neighborhood setting unit.

Other features and aspects will be apparent from the following detailed description, the drawings, and the claims.

### BRIEF DESCRIPTION OF THE DRAWINGS

FIG. 1 is a diagram illustrating a summary of a multimedia recommendation algorithm in consideration of users' rating according to an exemplary embodiment.

FIG. 2 is a diagram illustrating a method for recommending multimedia image based on user profile using feature-based collaborative filtering according to an exemplary embodiment.

FIG. 3 is a diagram illustrating regions extracted using the normalized cuts segmentation according to an exemplary embodiment.

FIG. 4 is a diagram illustrating background image item neighbor relationships preferred by a user according to an exemplary embodiment.

FIG. 5 is a diagram illustrating exemplary neighbor clusters configured by the set of background image contents preferred by a user.

FIG. 6 is a diagram illustrating an apparatus for recommending multimedia image based on user profile using feature-based collaborative filtering according to an exemplary embodiment.

FIG. 7 is a diagram illustrating the effect of a neighbor cluster and a feature dot according to an exemplary embodiment.

FIG. 8 is a diagram illustrating the effect of a training duration and a feature dot according to an exemplary embodiment.

FIG. 9 is a diagram illustrating a new item hit ratio based on a feature dot in accordance with the change of the number of neighbors according to an exemplary embodiment.

FIG. 10 is a diagram illustrating the change of a new item hit ratio based on a feature dot in accordance with the change of a training duration according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Generally, since collaborative filtering is determined not to be suitable for the recommendation of multimedia contents due to the following exemplary limitations, certain embodiments taught herein may disclose a method for comprehending and resolving one or more of the limitations.

Firstly, in a CF-based recommendation system, due to the sparsity of input data, the more the rating data of customers are acquired, the higher the accuracy of recommendation becomes. However, as contents used on wired/wireless websites increase together with the growth of an on-line multimedia service, the number of contents relatively increases in which there exist no rating data collected through the direct estimation of a customer or the analysis of purchase information. Accordingly, a customer-item matrix may merely be a sparse matrix, and reliability is reduced upon measurement of inter-customer similarity because less number of rating data are used in a process of searching neighborhood. Such a phenomenon finally serves as a main reason that decreases the accuracy of a recommendation result.

Secondly, since the collaborative filtering performs recommendation based on the rating data of customers for an item, it is impossible to know the rating of an item that any customer does not estimate like in a case of a new item, and thus, the item cannot be recommended before someone inputs the rating or purchases the item. Accordingly, in a case where the collaborative filtering is applied to a website which provides new multimedia contents according to the development of a multimedia contents technology and the rapid change of customers' rating, it can be fatal.

Accordingly, according to an exemplary embodiment, a method is provided for recommending a background image based on a user profile in which content-based filtering and collaborative filtering are combined. The content-based filtering is performed on the assumption of that users estimate items having similar contents as similar items. By predicting the estimation values of non-estimated items based on the content-based filtering, the method for recommending the background image based on the user profile in which the content-based filtering and the collaborative filtering are combined analyzes the similar rating trend between two users in consideration of an predicted estimation value with values estimated by actual users to resolve the basic limitations of the collaborative filtering. Accordingly, the accuracy of a recommendation may be increased.

In a recommendation method which has been developed for recommending a movie and music up to now, only a research has been made which uses a content attribute based on a keyword on the basis of the studies result of an information retrieval field. However, attribute information is input through the subjective determination of users in a method for extracting the content attribute based on the keyword, and thus, the method has limitations in analyzing users' rating for the content attribute of multimedia because it is difficult to accurately and objectively measure the attributes of various multimedia (for example, background image attributes include color, texture, shape and the like, music attributes include interval, time, tempo and the like, and video attributes include the color, texture and motion picture of a representative frame). Accordingly, the method according to an exemplary embodiment represents multimedia information preferred by individual customers as the dots (one rating cluster) of a multidimensional feature space, and thereafter calculates the geometrical distance between a customer for recommendation and other customers to obtain rating neighborhood. Thus, the above-described limitations of the collaborative filtering may be resolved.

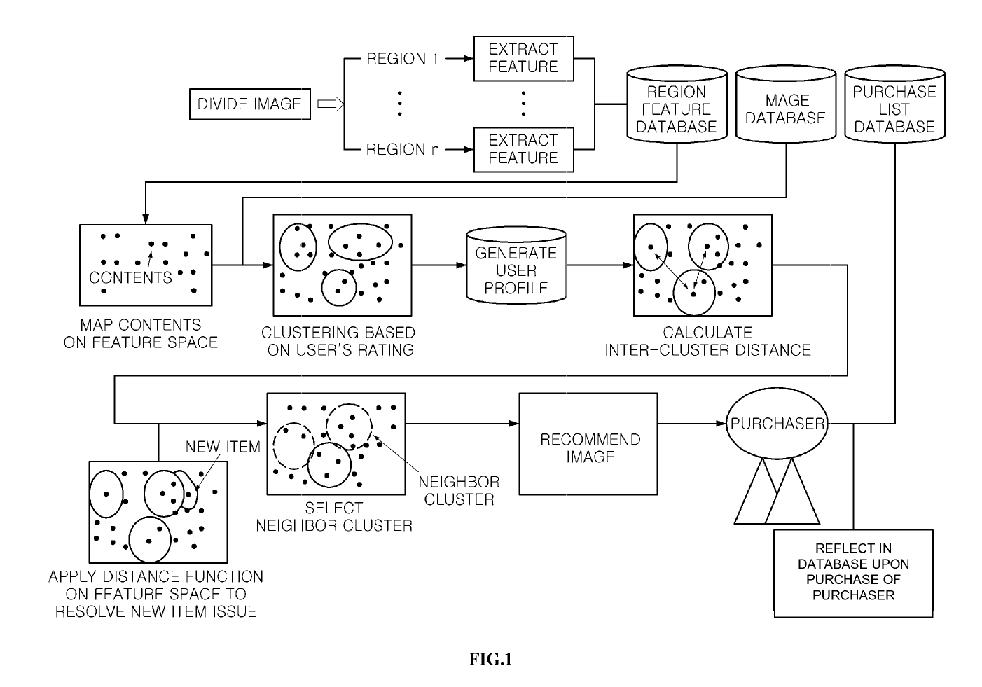

FIG. 1 illustrates the summary of a multimedia recommendation algorithm in consideration of users' rating according to an exemplary embodiment. Referring to FIG. 1, a method for recommending background image according to an exemplary embodiment intends to recommend background images, which are to be preferred by target users, based on a time attribute when the purchase specification of character images and the purchase pattern of background images for users, which used a mobile terminal for a certain duration in the past, are given. A new customer profile configuration method is provided that includes two phases, a model building phase and a background image recommending phase, as compared to the existing CF. The model building phase is performed once by a periodic time unit for building a reliable model from a customer purchase list database, whereas the background image recommendation phase is used for recommending contents in which the purchase likeness score of a target customer is high.

The model building phase is a phase that clusters background images purchased by users on a feature space by using an image dividing phase, a time attribute extracting phase and the purchase list database. The model building phase performs a background image dividing scheme on all background images in the database. At this point, one background image is divided into a plurality of meaning regions. The model building phase extracts various visual features such as color, texture, and shape from the regions of the background image. Since a localized feature based on a region can well represent an individual, it can more accurately comprehend the upper-level concepts of users than a globalized feature extracted from the total pixels of the background image. The model building phase analyzes the purchase list database to cluster background images purchased by users on the feature space, and builds a user profile. The background images can be represented as feature vectors on a feature vector space, respectively. Likewise, the regions can also be represented as dots on the feature vector space, respectively. That is, the background images purchased by the users are represented as a plurality of dots on the feature vector space, and the model building phase groups the dots to configure clusters by user. Compared to the CF scheme, a feature-based collaborative filtering (FBCF) scheme according to an exemplary embodiment represents the background images purchased by the users as the feature vectors on the feature vector space, and can measure inter-user rating with an inter-cluster distance function on the feature vector space by using a set of obtained clusters as the user profile.

The background image recommending phase searches the neighbors of a target customer by using the feature clusters generated in the model building phase. The background image recommending phase performs a k-nearest neighbors search scheme on a set of the feature clusters to constitute a neighbor cluster nearest to the cluster of the target customer, and finally recommends background images in which the purchase likeness score is included in an upper-Nth rank, among background images included in the clusters of the neighbor cluster and new items included in the cluster radius of the target customer. That is, the background image recommending phase can recommend contents having a similar attribute by using the characteristics of multimedia. The multimedia image content recommendation algorithm according to an exemplary embodiment is described below.

The background image content recommendation algorithm according to an exemplary embodiment receives the region feature database of background image contents, a purchase database, and a user profile P to output a recommended background image content list R.

The region feature database and the purchase database are built, that is, the background image content recommendation algorithm applies a background image division scheme on all background images in the database to configure regions. The background image content recommendation algorithm respectively extracts the feature vector “xᵢ={xᵢ₁, xᵢ₂, . . . , xᵢₖ} (herein, i=1, . . . , N)” of regions constituting character background images from a p-dimensional feature space R^{p}, and builds a background image region feature database. The background image content recommendation algorithm stores the purchase specification of background images on all users in the purchase database.

The user profile is generated, that is, the background image content recommendation algorithm groups the background images purchased by the users to configure the user profile with a set of feature clusters. The feature cluster is represented as a cluster being the bunch of the regions of background images that arbitrary user “a” purchased. The center, variance and effective radius of the cluster, and data and user information included in the cluster are stored in the user profile.

A neighbor cluster is configured, that is, contents in the profiles of a target customer “c” and the arbitrary user “a” configure a cluster, respectively. To obtain the neighbor cluster, a k-nearest query using the set of the feature clusters is performed. For example, the inter-cluster distance of the target customer “c” and the arbitrary user “a” is calculated using T²_{ca}, and the L number of neighbor clusters “H={h₁, h₂, . . . , h_{L}}, c¢H” for the target customer “c” is obtained in the ascending power of a value.

Finally, a recommendation list is generated, that is, the background image content recommendation algorithm calculates the purchase likeness score PLS(c, x) of the target customer “c” for background images “x” that the neighbor cluster purchased in the past and recommends the k number of upper contents “R={x₁′, x₂′, . . . , xₖ′}” in which the frequency of purchase is high.

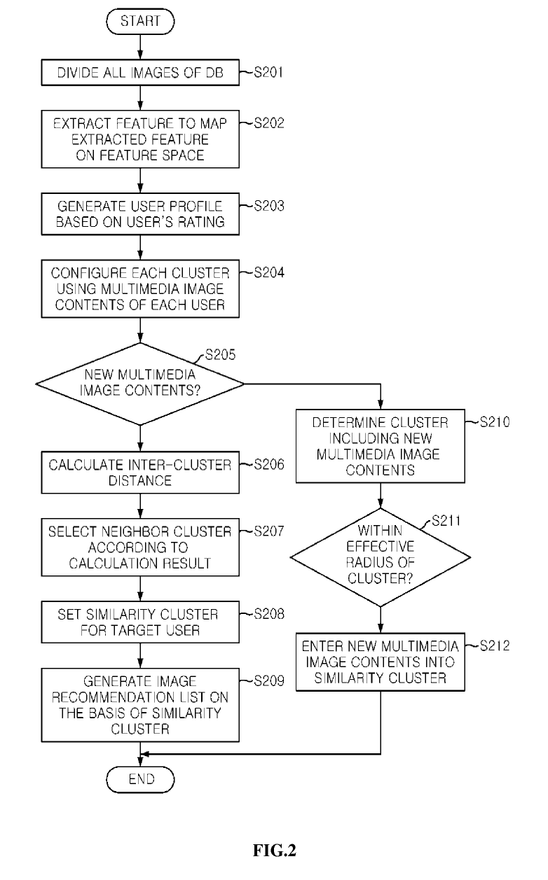

FIG. 2 is a diagram illustrating an exemplary method for recommending multimedia image based on user profile using feature-based collaborative filtering. Referring to FIG. 2, the method for recommending multimedia image includes dividing all background images in a database (DB) in operation S201, extracting a feature to map the extracted feature on a feature space in operation S202, generating a user profile based on a user's rating in operation S203, configuring each cluster by using each user's multimedia image contents in operation S204, determining whether new multimedia image contents are in operation S205, calculating an inter-cluster distance in operation S206, selecting a similarity cluster according to a result of the calculation in operation S207, setting neighborhood for a target user in operation S208, generating a background image recommendation list on the basis of the set neighborhood in operation S209, determining a cluster to enter the new multimedia image contents in operation S210, determining whether the new multimedia image contents are within the effective radius of the cluster in operation S211, and entering the new multimedia image contents into the similarity cluster in operation S212.

The method for recommending multimedia image based on user profile using feature-based collaborative filtering according to an exemplary embodiment includes (1) a process that builds a model from a customer purchase list database for each predetermined time to generate a user profile, and (2) a process that recommends a multimedia image in which the purchase likeness score of the target user is high using the built model. The user profile generation process is performed through the operations S201 to S203.

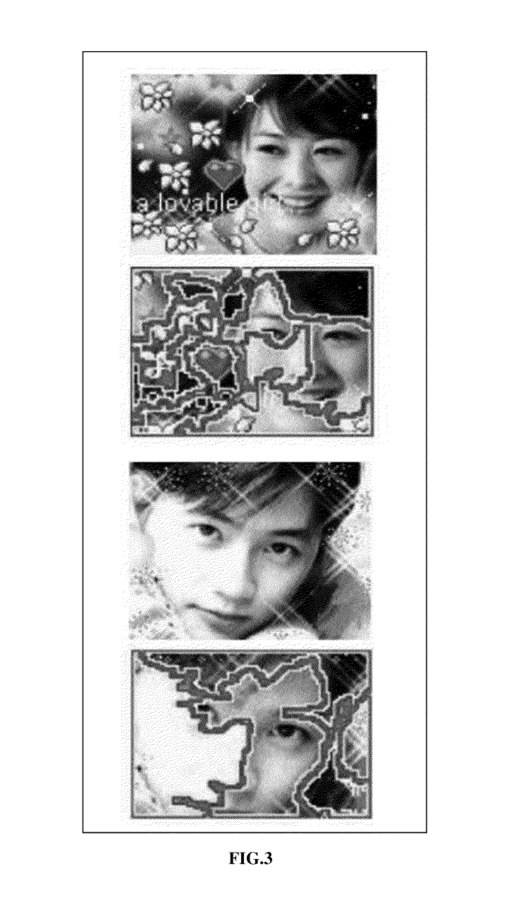

In the operation S201, all the background images in the database are divided. The method divides the background image into a plurality of meaning regions using the feature vector in a multidimensional attribute space on all the background images in the customer purchase list database. For this, the method treats the each pixel of all images in the customer purchase list database as the dot of the feature space by using the feature vector in the multidimensional attribute space, and divides the images by bunching similar pixels according to selected features. An algorithm into which a normalized cuts segmentation method is amended is used for the division of the background image. The normalized cuts segmentation method applies a graph theory scheme for classifying the set of the dots into subsets. This method may be applied in a case where the background image is divided into the regions, treats the each pixel of the background image as the dot of the feature space, and bunches very similar pixels according to the selected features. FIG. 3 illustrates regions extracted using the normalized cuts segmentation according to an exemplary embodiment. FIG. 3 illustrates an example of the original background image provided in the character image download service of SK Telecom (SKT) and an example of a background image in which regions are divided using the normalized cuts segmentation method, and regions classifying an object included in the background image have been made. That is, the background image is represented as a plurality of regions including the object.

In the operation S202, the method extracts features from the regions of the image divided through the operation S201 to map the extracted features on the feature space. The operation S202 is a process for resolving the sparsity of input data, and the method represents the user profile as the feature vectors in the multidimensional attribute space instead of the existing customer-item matrix in the operation S202. Accordingly, items preferred by the user are represented as the dots of the attribute space, which constitute a cluster. This reason is because the dots of the cluster are reduced so that limitations may occur in calculating the inter-cluster distance function, in a case where the input data is less. Moreover, the extracted feature includes at least one of the sizes of the region, the position of the region, second moment, the color of the region and texture, which are extracted from the regions of the image divided through the operation S201. One item is classified as a plurality of feature vectors, for example, a plurality of regions in a case of an image, and the method extracts the feature vector of the each region to represent the extracted feature vector as a plurality of dots on a space. In a case where a user purchases one background image, since a plurality of region feature vectors representing the background image is input, the sparsity of data can be resolved. That is, this is an attempt for representing one item as a plurality of dots on the attribute space.

For this, the method uses the attribute such as the size RS of the region, the position of the region and the second moment for representing the shape of the image. When the height of the image is H, the width of the image is W and the extent of the region is A, the size RS of the region is obtained as the area of a region normalized by the size of the image. The position of the region represents the relative position of an object of “RS=A/(W×H)” in the image. To maintain scale invariance, the each pixel is normalized by the height and width of the image. First, the center coordinates of the region are the average “x_{cm}, y_{cm}” of a histogram representing the pixel distribution of the region according to row and column, and the position “x_{loc}, y_{loc}” of the region is a value in which the average “x_{cm}, y_{cm}” is normalized on the width and height of the image. The second moment is the standard deviation of the pixels of the region calculated on the basis the center coordinates of the region. When the number of the pixels of the region is N, the second moment of the region on the x-axis and the y-axis may be expressed as Equation (1) below.

$${( second moment )}_{x} = \frac{1}{( W / 2 )} \sqrt{\frac{{\sum }_{n = 1}^{N} {( {x}_{n} - {x}_{cm} )}^{2}}{N}} , \\ {( second moment )}_{y} = \frac{1}{( H / 2 )} \sqrt{\frac{{\sum }_{n = 1}^{N} {( {y}_{n} - {y}_{cm} )}^{2}}{N}} \qquad ( 1 )$$

Compactness is a rate of the area of the region divided by the square of the length of the round of the region. When the shape of the region is circle, the compactness has the greatest value. When the shape of the region is concave, the compactness has a less value. Convexity represents the convex degree of the region. The area of the region can be obtained by being divided by the area of the convex hull. These may be expressed as Equation (2) below.

Compactness=A/P²,

Convexity=A/Aₕᵤₗₗ (2)

Color is one of useful characteristics representing an object. The color of the region is represented as six-dimensional attribute values in which the average and standard deviation of the pixels are calculated on an L*a*b color space. Texture represents the change of a shading pattern in the region. The method averages the reactions of the pixels in the region to a filter by using a linear filter bank having different scales and directions, wherein the even part of the filter bank uses the second differentiation of Gaussian Kernel and the odd part of the filter bank uses Hilbert transform.

In the operation S203, the method generates the user profile based on the user's rating. In the operation S230, the method analyzes the purchase list database to represent the background image purchased by the user as the set of the feature clusters based on the user's rating, and thus, generates the user profile. At this point, configuring the set of the feature clusters is for more efficiently finding the neighbor cluster. Moreover, the feature cluster includes at least one of the dots represented as the regions of the background images that the arbitrary user purchased, the center, variance and effective radius of the cluster and information for the user that has purchased the background image of the cluster. Upon generation of the user profile, the feature cluster includes the dots represented as the regions of the background images that the arbitrary user “a” purchased, and includes the center, variance and effective radius of the cluster and information for the user that has purchased the background image of the cluster. The feature cluster is represented as “UP={C₁, C₂, . . . , Cₖ}. Herein, Cᵢ is the set {xᵢ₁, xᵢ₂, . . . , xᵢₙ}={{xⱼ₁₁, xⱼ₁₂, . . . , xⱼ₁ₘ}, {xᵢ₂₁, xᵢ₂₂, . . . , xᵢ₂ₘ}} of the regions constituting the background images purchased by the user. nᵢ is the number of the background images purchase by a user “i”, and {xᵢ₁, xᵢ₂, . . . , xᵢₙ} is the set of the regions constituting a background image “xᵢ₁”. The cluster “Cᵢ” includes information for the center “xᵢ” of the cluster, weight covariance matrix “S”, effective radius “Γ” and information for the user. These may be expressed as Equation (3) below.

$$\overline{x} = ( {x}_{2} , … , {x}_{p} ) ∈ {R}^{p} , {S}_{i} = {\sum }_{k = 1}^{{n}_{i}} {v}_{ik} ( {x}_{ik} - {\overline{x}}_{i} ) ( {x}_{ik} - {\overline{x}}_{i} ) \qquad ( 3 )$$

An average vector determines the position of a focal plane ellipse. On the other hand, the covariance matrix represents a shape and a direction. The relative weight of the each cluster is determined as the sum of the appropriateness points of the dots in the each cluster. Generally, a cluster may be represented as an ellipse. The effective radius is a critical value for determining whether the new background image “x” is included in a given cluster. When an arbitrary dot “x” is disposed in the ellipse, characteristic like Equation (4) below may be satisfied.

$${( x - \overline{x} )}^{′} {( \frac{1}{n} S )}^{- 1} ( x - \overline{x} ) < \frac{( n - 1 ) p}{( n - p )} {F}_{p , n - p} ( α ) \qquad ( 4 )$$

On the assumption of that data are based on a normal distribution, it is assumed that α is a significance level. On the given significance level, the 100(1−α) % of the data (generally, 95% to 99%) is disposed in the ellipse, a distance function “F_{p, n-p}(α)” is based on a distribution in which the degree of freedom is “p, n−p”. As αdecreases, the given effective radius increases. The dots external to the ellipse is recognized as an outlier, and configures a new cluster. Assuming that the size of a cluster “Cᵢ” representing the set of the regions of the background images purchased by an ith user is nᵢ, an average is

$$“ {x}_{i} = {\sum }_{x ∈ {C}_{i}} \frac{x}{{n}_{i}} ”$$

and variance is “Sᵢ=Σ_{xεC}_{ᵢ}(x− x̅ᵢ)^{T}”, the covariance of two clusters Cᵢ and Cⱼ is “Sₚᵢⱼ=(Sᵢ+Sⱼ)/(nᵢ+nⱼ₋₂)”.

In the exemplary embodiment, the function Tij of Hotelling is used as the inter-cluster distance function suitable for the configuration of a neighbor cluster as follows. The distance function between the two clusters Ci and Cj may be defined as expressed in Equation (5) below.

$${T}_{ij }^{2} = \frac{{n}_{i} {n}_{j} ( n - 2 )}{{( {n}_{i} + {n}_{j} )}^{2}} {( {m}_{i} - {m}_{j} )}^{T} {S}_{{P}_{ij}}^{- 1} ( {m}_{i} - {m}_{j} ) \qquad ( 5 )$$

The process “2”, which recommends the multimedia image in which the purchase likeness score of the target user is high after generating the user profile, is performed in the operations S204 to S212. The process “2” includes a process “d” (the operations S204 to S208, the operations S210 to S212) that sets the similarity cluster using the multimedia image contents in the profiles of the target user and the arbitrary user, and a process “e” (the operation S209) that generates the background image recommendation list on the basis of the set similarity cluster.

In the operation S204, the method configures each cluster using the multimedia image contents of the each user.

In the operation S205, the method determines whether the multimedia image contents are new. This is for determining whether a new item is before determining whether the distance function is applied on the feature space for resolving the recommendation issue of a new item in the operations S210 to S212. Herein, the new item was not purchased before, and does not have rating. If the new item has the rating, it can be recommended. To resolve this, the exemplary embodiment gives a virtual rating to the new item and recommends it. Generally, three giving schemes are used for the giving of the virtual rating. A first giving scheme gives the maximum value, a second giving scheme gives an average value, and a third giving scheme gives the minimum value. The exemplary embodiment applies the first giving scheme of giving the maximum value.

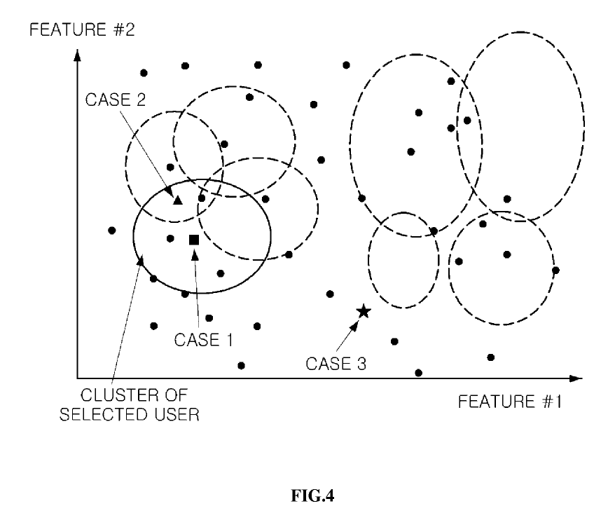

The operations S210 to S212 are for resolving the recommendation issue of a new item, and will be described below with reference to background image item neighbor relationships (illustrated in FIG. 4) preferred by a user. FIG. 4 illustrates the background image item neighbor relationships preferred by the user according to an exemplary embodiment. Referring to FIG. 4, a case “1”, a case “2” and a case “3” are new multimedia image contents and are represented as multidimensional feature vectors, and thus, are represented as dots on the feature space. The case “1” represents multimedia image contents purchased by a selected user among the new multimedia image contents, the case “2” represents multimedia image contents included in the cluster of the selected user even though the contents among new items have not been purchased. The case “3” represents multimedia image contents that have not been purchased among the new items and are not included in the cluster of the selected user. In a case where the contents are the new multimedia image contents as a result of the determination of step S205, the method determines a cluster to enter a new multimedia image content “x_{new}” when the g number of clusters “C₁, . . . , C_{g}” are given using a Bayesian classification scheme according to an exemplary embodiment in the operation S210. Subsequently, the method determines whether the case “3” is disposed within the effective radius of a corresponding cluster in the operation S211. When the determination result shows that the case “3” is disposed within the effective radius of the corresponding cluster, the case “3” is included in the similarity cluster in the operation S212, thereby enabling to recommend the new multimedia image contents (new item). At this point, the Bayesian classification function of the cluster “Cᵢ” may be expressed as Equation (6) below.

$${\hat{d}}_{i} ( {x}_{new} ) = - \frac{1}{2} {( {x}_{new} - \overline{{x}_{i}} )}^{′} {S}_{pooled}^{- 1} ( {x}_{new} - \overline{{x}_{i}} ) + ln ( {w}_{i} ) \qquad ( 6 )$$

Where wᵢ is the normalized weight of the ith cluster, and the weight is calculated through the sum of users' ratings.

The method selects the cluster “Cₖ” having the greatest value among d₁(x_{new}), d₂(x_{new}), . . . , d_{g}(x_{new}), and thereafter examines whether x_{new} is within the effective radius of the cluster as may be expressed in Equation (7) below.

$${( {x}_{new} - \overline{{x}_{k}} )}^{′} {( \frac{1}{n} S )}^{- 1} ( {x}_{new} - \overline{{x}_{k}} ) < \frac{( n - 1 ) p}{( n - p )} {F}_{p , n - p} ( α ) \qquad ( 7 )$$

That is, when the above Equation (7) is satisfied, a new item is recommended. Statistically, the effective radius of a cluster is based on a distribution “F” in which the degree of freedom is “p, n−p” and a reliability level is “α”.

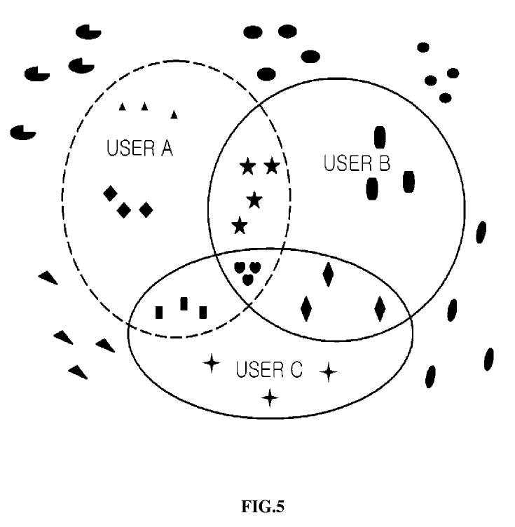

The operations S206 to S208 are a process that sets the similarity cluster on the basis of the image of the existing database in a case where the new multimedia image contents are not included, and will be described below with reference to FIG. 5. In the operation S206, the method calculates the inter-cluster distance. In the operation S207, the method selects a neighbor cluster according to a result of the calculation of the operation S206. In the operation S208, the method sets the similarity cluster for the target user on the basis of the neighbor cluster. Description related to this will be made below with reference to a diagram (FIG. 5) illustrating neighbor clusters configured by the set of background image contents preferred by a user.

FIG. 5 illustrates neighbor clusters configured by the set of background image contents preferred by a user. The existing CF algorithm calculates an inter-user correlation by using a cosine function or a person coefficient, but this scheme has difficulty in finding a neighborhood having rating similar to that of a target user. Compared to a case that finds and recommends a neighbor by correlation using the existing purchase information or web-log information, the exemplary embodiment can recommend items having a similar attribute because of representing a multimedia item on a feature space. Herein, FIG. 5 represents the set of background image items preferred by users “A”, “B” and “C” as clusters “C₁”, “C₂” and “C₃” on a two-dimensional feature space respectively, and the regions of all the images of a purchase database may be represented as dots on the feature space. At this point, the set of the background images purchased by the each user configures a cluster. As illustrated in FIG. 5, the set of the background images purchased by the user “A” is composed of five images and sixteen regions. Among these, the number of the background images which the users “A” and “B” have purchased together is four, the number of the background images which the users “A” and “C” have purchased is three, and the number of the background images which the users “A”, “B” and “C” have purchased together is three. According to the exemplary embodiment, since the background image items may be represented as the dots on the multidimensional feature space, the method may calculate the distance between the target user and other user to obtain an actual neighborhood. A Euclidean distance function is widely used as the inter-cluster distance function. The function is simple and easy to calculate, and operates well when the cluster is uniformly distributed and the shape of the cluster is circle. However, the each user's rating is not the same and their distributions are different as illustrated in FIG. 5. Items in the profiles of the target customer “c” and the arbitrary user “a” configure the cluster, respectively. To calculate the neighbor cluster, the k-nearest query is performed using a feature cluster tree. For example, in a case that sets a similar cluster, the inter-cluster distance of the target customer “c” and the arbitrary user “a” is calculated using T²_{ca} in the operation S206, and the L number of neighbor clusters “H={h₁, h₂, . . . , h_{L}}, c¢H” for the target customer “c” is obtained in the ascending power of the value “T²_{ca}” in the operation S207. The method may align the similarity cluster in ascending power according to the obtained distance value to select the similarity cluster “L”. Finally, the method determines a similarity cluster “H={h₁, h₂, . . . , h_{L}}, c¢H” for the target customer “c” in the operation S208.

In the operation S209, the method generates the background image recommendation list on the basis of the similarity cluster that has been set in the operation S208. For this, the method extracts the specific number of upper multimedia image contents, in which the frequency of purchase is high, from the set similarity cluster to generate a recommendation list. This is a final step for recommending the item, and the method extracts the k number of upper items “R={x₁′, x₂′, . . . , xₖ′}”, in which the frequency of purchase is high, from the set similarity cluster by using most-frequent item recommendation. The purchase likeness score of the target user for the item “x” may be expressed as Equation (8) below.

$$PLS ( c , x ) = \frac{{\sum }_{a ∈ H} {R}_{x} \times sim ( c , a )}{{\sum }_{a ∈ H} sim ( c , a )} \qquad ( 8 )$$

where the user “a” is obtained from the similarity cluster “H”, and sim(c, a) is the frequency of purchase in which the neighborhood has purchased the image “x” and may be expressed as Equation (9) below.

$$sim ( c , a ) = \frac{{Max}_{u , w ∈ H} [ d ( u , w ) ] - d ( c , a )}{{Max}_{u , w ∈ H} [ d ( u , w ) ] - Min [ d ( u , w ) ]} \qquad ( 9 )$$

The above Equation (9) is a function for calculating the similarity between the target user “c” and the neighbor user “a”, and calculates and normalizes the inverse number of the value obtained from the inter-cluster distance function to obtain the similarity. The users “u” and “w” belong to the neighborhood “H” of the target user.

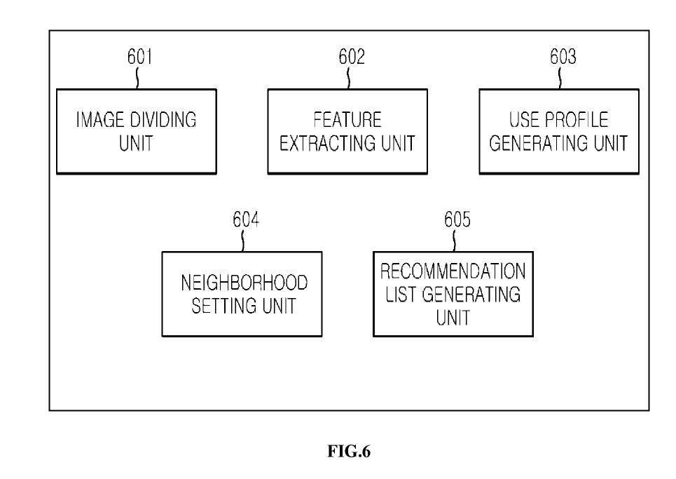

FIG. 6 illustrates an exemplary apparatus for recommending multimedia image based on a user profile using feature-based collaborative filtering according to an exemplary embodiment. Referring to FIG. 6, the apparatus for recommending the multimedia image based on the user profile using the feature-based collaborative filtering according to an exemplary embodiment includes an image dividing unit 601, a feature extracting unit 602, a user profile generating unit 603, a neighborhood setting unit 604, and a recommendation list generating unit 605. Herein, the image dividing unit 601 divides a background image into a plurality of meaning regions on all the background images in a customer purchase list database by using a feature vector. The feature extracting unit 602 extracts a feature from the regions of the image divided by the image dividing unit 601 to map the extracted feature on a feature space. The user profile generating unit 603 analyzes the customer purchase list database, represents a background image purchased by a user as the set of feature clusters based on the user's rating, and generates a user profile. The neighborhood setting unit 604 sets a neighborhood by using multimedia image contents in the profiles of a target user and an arbitrary user. The recommendation list generating unit 605 generates a background image recommendation list on the basis of the neighborhood set by the neighborhood setting unit 604.

In an experiment, actual data provided from the SKT have been used. The configuration of data are composed of 25, 680 purchase list data, 5, 326 background image data, and 476 profile data of a purchaser (that is, customer information data). The purchase list data is composed of a purchasing customer ID, an image-purchasing date and a purchased image ID. The background image data is composed of a background image ID, a background image name and the sale data of the background image. The customer information data is composed of a customer ID, a date in which the customer has first purchased the background image, a final purchase date and the total number of times the background image is purchased. A region feature data is divided into the background image ID and the background image, and is composed of a region ID divided by region, a color-based six-dimensional feature data, a shape-based six-dimensional feature data and a texture-based eight-dimensional feature data. In the experiment, data was limited to data covering from June to August, 2004. To improve the reliability of the experiment and perform the recommendation of good quality, since a training data needs be filtered, the customers for the experiment was limited to only customers that had purchased fourteen or more background images from the SKT among the customers.

In an experiment, the feature dot of the background image of a mobile phone uses color, shape and texture. To estimate the experiment, a hit ratio is used. The hit ratio is the ratio of the number of recommended images and the number of purchased images. If an image is not purchased after being recommended, the hit ratio is not increased. That is, although a recommendation system recommends an image to a purchaser, if the purchaser does not purchase the image, the hit ratio is not increased. In the experiment, the hit ratio has been measured in various terms, and the following description will be made on what changes occurs in performance by using the feature dot as color, shape and texture. Moreover, the above experiment has been made on which neighbor of a neighbor set in some way has the best performance by differently setting the number of neighbors.

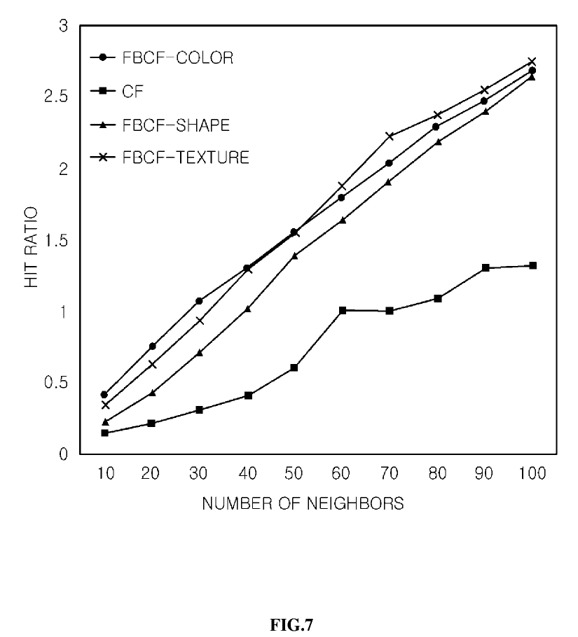

FIG. 7 illustrates the effect of a neighbor cluster and a feature dot according to an exemplary embodiment. As illustrated in FIG. 7, the hit ratio performance estimation of the FBCF, which uses the region feature dot as color, shape and texture, and the existing CF will be made. In the hit ratio according to the number of the neighbors and the feature dot, it is shown that the FBCF scheme of using texture as the region feature dot has further increased by up to 250% than the existing CF. Moreover, when the number of the neighbors increases by from ten to hundred, the FBCF scheme has been increased by up to 700% in the success ratio of recommendation. In performance by feature, it is shown that the scheme of using the region feature dot as texture has performance 157% higher than the scheme of using the region feature dot as shape to the utmost. As the number of the neighbors increases, the FBCF scheme performs a recommendation based on the images of neighbors having a similar trend, and thus, it has resulted in the high success ratio of recommendation. If the number of the neighbors increases, a recommendation success ratio increases because a recommendable list increases. The hit ratio may be expressed as Equation (10) below.

Hit ratio=Metric hit/Metric Recommendation (10)

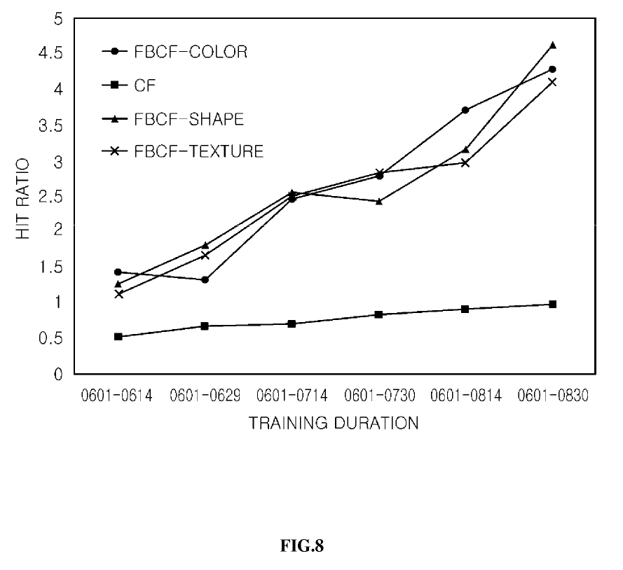

FIG. 8 illustrates the effect of a training duration and a feature dot according to an exemplary embodiment. FIG. 8 illustrates the experiment result of the change amount of the hit ratio according to that the change of the training duration in which a cluster is made of a background image purchase list. As the training duration is extended, the cluster and the cluster of a neighbor also increase. It is shown that the FBCF scheme has increased by up to 400% in performance than a result of the existing CF scheme. An experiment on a new item is made for resolving the recommendation issues of the new item in the existing CF scheme. The experiment for the recommendation of the new item applies a method that gives the virtual rating to a non-purchased new item to thereby enable even the new item to be recommended, like the existing item. The experiment applied a method that gives the virtual rating the maximum value of the rating values of a cluster including the new item. In FIGS. 7 and 8, it is shown that the CF scheme has a similar result in all cases, but it is shown that the FBCF scheme result in the rapid increase of the hit ratio as the neighbor cluster and the list of a cluster increases. This can analogize that the more data, the higher the quality of recommendation becomes. The intelligent element of the recommendation system may be the amount of data, and may be a data mining technology capable of well selecting the data.

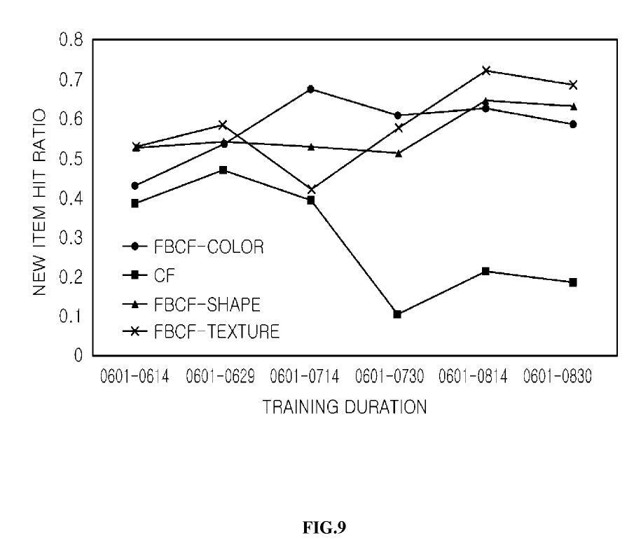

FIG. 9 illustrates a new item hit ratio based on a feature dot in accordance with the change of the number of neighbors according to an exemplary embodiment. In the CF, a recommendable new item merely is an item purchased by a selected user or an item that is included in the cluster of the selected user even though it has not been purchased among new items. On the other hand, the FBCF can recommend the item recommendable by the CF, and can also recommend an item that is not still included in the cluster of the selected user. FIG. 9 illustrates the new item hit ratio based on the feature dot on the change of the number of the neighbors, and the new item hit ratio may be expressed as Equation (11) below.

New item hit ratio=Metric hit/Metric Recommendation (11)

In FIG. 9, it is shown that the new item hit ratio of FBCF-TEXTURE is highest, the new item hit ratio of FBCF-SHAPE is the same as that of the CF, and the new item hit ratio of FBCF-COLOR is lowest. In performance on the new item hit ratio, it is shown that the FBCF-TEXTURE increases by 80% than the CF scheme. In the experiment of FIG. 9, the new item recommendation of the CF, however, is not performed due to a new item but performed as an accident result, and the three cases disclosed in embodiments of the present invention have been applied to the FBCF. Particularly, the case “3” has made the experiment by designating the maximum virtual rating in a process that enters a mobile background, which is not included in any cluster, into the cluster.

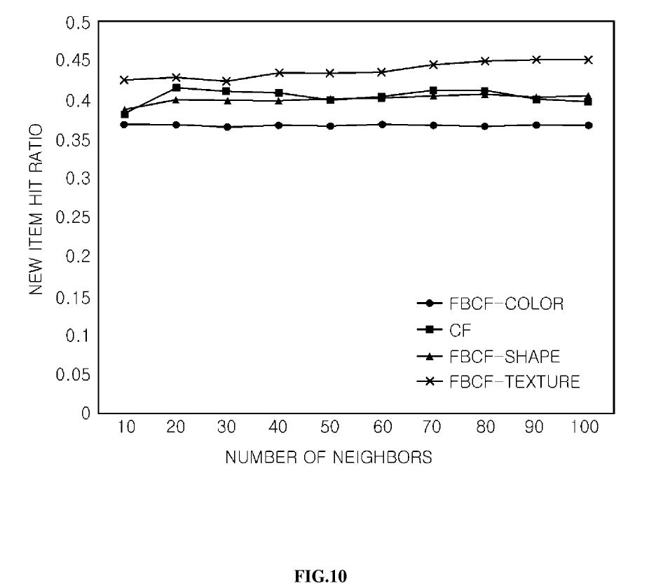

FIG. 10 illustrates the change of a new item hit ratio based on a feature dot in accordance with the change of a training duration according to an exemplary embodiment. It can be seen that the hit ratio increases as the training duration is extended in the FBCF scheme, but the new item hit ratio is irregularly changed in the CF scheme. In the CF scheme, since information of the new item is lack, the new item may not be recommended appropriately. An experiment result of the FBCF scheme into which the CF scheme has been improved shows that the new item hit ratio is gradually increased as the training duration is extended.

According to certain examples described above, a method and apparatus for recommending background image based on user profile recommends a background image based on a user profile using feature-based collaborative filtering, and thus, may resolve limitations that the accuracy of a recommendation result decreases in a case where input data related to customer's rating are sparse and a new item cannot be recommended in a case of the new item. Accordingly, a recommendation method most suitable for multimedia image contents may be provided.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for recommending a multimedia image based on a user profile using feature-based collaborative filtering, the method comprising:
building a model from a customer purchase list database for each predetermined time to generate the user profile; and
recommending the multimedia image, in which a purchase likeness score of a target user is at a predetermined level, by using the built model.

2. The method of claim 1, wherein the generating of the user profile comprises:
dividing an image into a plurality of meaning regions on all images of the customer purchase list database by using a feature vector of a multidimensional attribute space;
extracting a feature from the divided regions of the image to map the extracted feature on a feature space; and
analyzing the customer purchase list database, representing an image purchased by a user as a set of feature clusters based on a user's rating, and generating the user profile.

3. The method of claim 2, wherein the dividing of the image comprises treating each pixel of all the images of the customer purchase list database as a dot of the feature space by using the feature vector of the multidimensional attribute space, and dividing the image by bunching similar pixels according to a selected feature.

4. The method of claim 2, wherein the feature extracted from the divided regions of the image comprises at least one of a size of the region, a position of the region, a second moment, a color of the region, and texture, which are extracted from the divided regions of the image.

5. The method of claim 2, wherein the feature cluster comprises at least one of dots represented as regions of a plurality of images that an arbitrary user purchased, a center, variance and effective radius of a cluster and information for a user that has purchased the image of the cluster.

6. The method of claim 1, wherein the recommending of the multimedia image comprises:
setting a neighborhood by using multimedia image contents in profiles of a target user and an arbitrary user; and
generating an image recommendation list on the basis of the set neighborhood.

7. The method of claim 6, wherein the setting of the neighborhood comprises:
configuring each cluster by using the multimedia image contents in the profiles of the target user and the arbitrary user;
calculating a distance between the each cluster through a query;
selecting a neighbor cluster according to the calculated distance; and
setting a similarity cluster for a target user of the neighbor cluster.

8. The method of claim 7, further comprising:
determining a cluster to enter a new multimedia image content, when the new multimedia image content, which was not purchased in the past and is not comprised in a cluster of each user, is provided; and
entering the new multimedia image content into the similarity cluster, when the new multimedia image content is within an effective radius of the determined cluster.

9. The method of claim 6, wherein the generating of the image recommendation list comprises extracting the specific number of upper multimedia image contents, in which a frequency of purchase is high, from the set neighborhood to generate the image recommendation list.

10. A computer-readable storage medium storing a program to recommend a multimedia image based on a user profile using feature-based collaborative filtering, comprising instructions to cause a computer or an apparatus to:
build a model from a customer purchase list database for each predetermined time to generate the user profile; and
recommend the multimedia image, in which a purchase likeness score of a target user is at a predetermined level, by using the built model.

11. The computer-readable storage medium of claim 10, wherein to generate the user profile, further comprising instructions to cause the computer or the apparatus to:
divide an image into a plurality of meaning regions on all images of the customer purchase list database by using a feature vector of a multidimensional attribute space;
extract a feature from the divided regions of the image to map the extracted feature on a feature space; and
analyze the customer purchase list database, represent an image purchased by a user as a set of feature clusters based on a user's rating, and generate the user profile.

12. The computer-readable storage medium of claim 11, wherein to divide the image, further comprising instructions to cause the computer or the apparatus to:
treat each pixel of all the images of the customer purchase list database as a dot of the feature space by using the feature vector of the multidimensional attribute space; and
divide the image by bunching similar pixels according to a selected feature.

13. The computer-readable storage medium of claim 11, wherein the feature extracted from the divided regions of the image comprises at least one of a size of the region, a position of the region, a second moment, a color of the region, and texture, which are extracted from the divided regions of the image.

14. The computer-readable storage medium of claim 11, wherein the feature cluster comprises at least one of dots represented as regions of a plurality of images that an arbitrary user purchased, a center, variance and effective radius of a cluster and information for a user that has purchased the image of the cluster.

15. The computer-readable storage medium of claim 10, wherein to recommend the multimedia image, further comprising instructions to cause the computer or the apparatus to:
set a neighborhood by using multimedia image contents in profiles of a target user and an arbitrary user; and
generate an image recommendation list on the basis of the set neighborhood.

16. The computer-readable storage medium of claim 15, wherein to set the neighborhood, further comprising instructions to cause the computer or the apparatus to:
configure each cluster by using the multimedia image contents in the profiles of the target user and the arbitrary user;
calculate a distance between the each cluster through a query;
select a neighbor cluster according to the calculated distance; and
set a similarity cluster for a target user of the neighbor cluster.

17. The computer-readable storage medium of claim 16, further comprising instructions to cause the computer or the apparatus to:
determine a cluster to enter a new multimedia image content, when the new multimedia image content, which was not purchased in the past and is not comprised in a cluster of each user, is provided; and
enter the new multimedia image content into the similarity cluster, when the new multimedia image content is within an effective radius of the determined cluster.

18. The computer-readable storage medium of claim 15, wherein to generate the image recommendation list, further comprising instructions to cause the computer or the apparatus to extracting the specific number of upper multimedia image contents, in which a frequency of purchase is high, from the set neighborhood to generate the image recommendation list.

19. An apparatus for recommending a multimedia image based on a user profile using feature-based collaborative filtering, the apparatus comprising:
an image dividing unit to divide an image into a plurality of meaning regions on all images of a customer purchase list database by using a feature vector;
a feature extracting unit to extract a feature from the regions of the image divided by the image dividing unit to map the extracted feature on a feature space;
a user profile generating unit to analyze the customer purchase list database, represent an background image purchased by a user as a set of feature clusters based on a user's rating, and generate the user profile;
a neighborhood setting unit to set a neighborhood by using multimedia image contents in profiles of a target user and an arbitrary user; and
a recommendation list generating unit to generate a background image recommendation list on the basis of the neighborhood set by the neighborhood setting unit.
